(19) United States
(12) Patent Application Publication
(10) Pub. No.: US 2014/0095120 A1
(43) Pub. Date: Apr. 3, 2014

(54) DEVELOPMENT, PROGRAMMING, AND DEBUGGING ENVIRONMENT

(71) Applicant: Cypress Semiconductor Corporation, San Jose, CA (US)

(72) Inventors: Haneef Mohammed, Beaverton, OR (US); Jack Griffin, West Linn, OR (US); Christopher Keeser, San Jose, CA (US); Mark Hastings, Mukilteo, WA (US)

(73) Assignee: Cypress Semiconductor Corporation, San Jose, CA (US)

(21) Appl. No.: 14/035,836

(22) Filed: Sep. 24, 2013

Related U.S. Application Data
(63) Continuation of application No. 13/004,001, filed on Jan. 10, 2011, now abandoned.
Application No. 13/004,001 is a continuation-in-part of application No. 12/776,175, filed on May 7, 2010.
(60) Provisional application No. 61/293,532, filed on Jan. 8, 2010.
(60) Provisional application No. 61/176,272, filed on May 7, 2009.

(51) Int. Cl. G06F 17/50

(52) U.S. Cl. CPC G06F 17/50; G06F 17/5009
USPC 703/1

(57) ABSTRACT

A method includes providing a design interface to design a device schematic for a programmable device and receiving a placement of graphical objects in the device schematic, wherein the graphical objects represent components that are both internal and external to the programmable device being configured. The method further includes assigning the graphical objects into one of an internal domain and an external domain and displaying, by the processing device, the graphical objects from both the internal domain and the external domain in a single view of the design interface.

### RELATED APPLICATIONS

This patent application is a continuation of U.S. application Ser. No. 13/004,001, filed Jan. 10, 2011, which claims priority to U.S. Provisional Patent Application No. 61/293,532, filed on Jan. 8, 2010 and is a continuation-in-part of U.S. application Ser. No. 12/776,175, filed May 7, 2010, which claims priority to U.S. Provisional Patent Application No. 61/176,272, filed May 7, 2009, all of which are incorporated by reference herein.

### TECHNICAL FIELD

This disclosure relates generally to electronic systems, and, more particularly, to developing, programming, and debugging environment for programmable systems.

### BACKGROUND

Microcontroller manufacturers and vendors often supply their customers with development tools that allow programmers to create software for the microcontrollers to execute. Similarly, many configurable hardware manufacturers will provide their customers with specialized hardware configuration tools that allow designers the ability to configure their hardware devices.

Some electronic systems include both configurable hardware components and a processing device, which can be programmed and configured to work together to implement various functions. When configuring these electronic systems, designers often will utilize software tools to program the processing device and utilize the specialized hardware configuration tools to configure the hardware components. In other words, the system designers manually manage multiple projects, e.g., the use of the multiple development tools, with differing development methodologies when attempting to cohesively develop, program, and debug these electronic systems.

### SUMMARY

The patent application describes a method including receiving hardware description code that generically describes circuitry, and translating the hardware description code into one or more configuration files specific to a programmable system. The method also includes generating program code for a microcontroller of the programmable system based, at least in part, on the hardware description code, and configuring the programmable system to implement the circuitry according to the configuration files and the program code.

A system includes an interface device to receive hardware description code that describes hardware circuitry for a programmable system to implement, and to receive an indication to initiate automatic configuration and programming of the programmable system based on the hardware description code. The system further includes a processing system, responsive to the indication, to automatically generate one or more hardware configuration files and program code based, at least in part, on the hardware description code, and to automatically send the configuration files and the program code to the programmable system, wherein the programmable system is configured to implement the hardware circuitry according to the configuration files and the program code.

### BRIEF DESCRIPTION OF THE DRAWINGS

FIG. 1 shows a programmable system configurable by a processing system implementing an integrated development environment according to embodiments of the invention.

FIG. 2 illustrates an embodiment of a core architecture of a Programmable System-on-Chip (PSoC™) shown in FIG. 1.

FIG. 3 illustrates an example embodiment of the processing system shown in FIG. 1.

FIG. 4 is an example operational flowchart for the processing device implementing the integrated development environment according to embodiments of the invention.

FIG. 5 is an example operational flowchart for the integrated development environment according to embodiments of the invention.

FIG. 6 is an example screen shot showing a warning dialog for annotation elements in a schematic generator, according to embodiments of the invention.

FIG. 7 is an example screen shot showing the differentiation of annotation elements in a schematic generator, according to embodiments of the invention.

FIG. 8 is an example screen shot showing components in a first domain in a schematic generator, according to embodiments of the invention.

FIG. 9 is an example screen shot showing components in both a first domain and a second domain in a schematic generator, according to embodiments of the invention.

FIG. 10 is a diagram showing a logic separation between a first domain and a second domain for a schematic generator, according to embodiments of the invention.

FIG. 11 is a block diagram illustrating one embodiment of a computer system, according to an embodiment.

### DETAILED DESCRIPTION

A Programmable System-on-Chip (PSoC™), such as that used in the PSoC™ family of products offered by Cypress Semiconductor Corporation (San Jose, Calif.), or other electronic system can include a microcontroller or other processing device and configurable hardware components, such as programmable analog and/or digital blocks. A processing system can implement a unified integrated development environment that allows designers to develop applications and program both the configurable hardware components and the microcontroller of the PSoC™ and/or electronic system. Embodiments are shown and described below in greater detail.

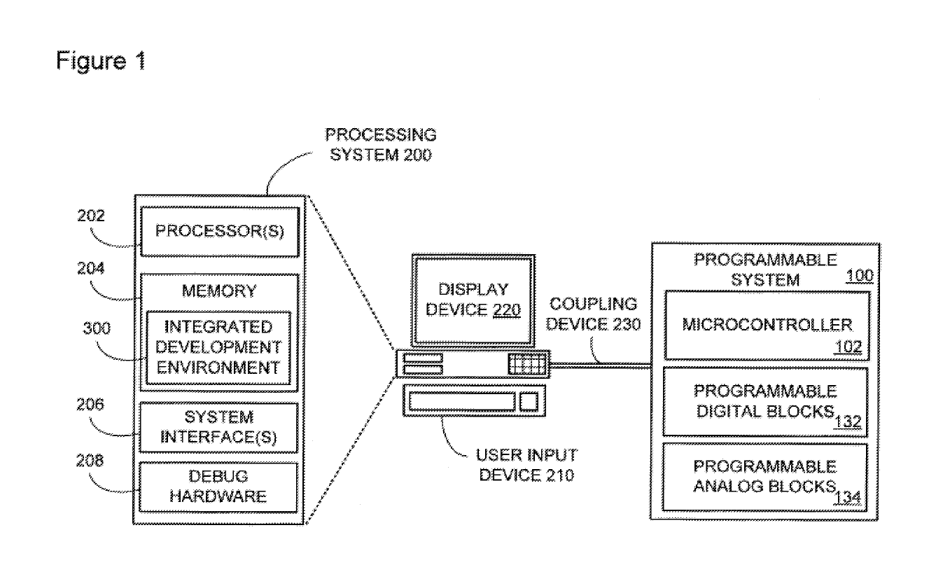

FIG. 1 shows a programmable system 100 configurable by a processing system 200 implementing an integrated development environment 300 according to embodiments of the invention. Referring to FIG. 1, the programmable system 100 includes a microcontroller 102 and configurable hardware components, such as programmable digital blocks 132 and programmable analog blocks 134. The microcontroller 102 can be programmed (and reprogrammed) and the programmable digital and analog blocks 132 and 134 can be configured (and reconfigured) to implement various applications and perform a variety functions. Embodiments of the programmable system 100 will be described below in greater detail.

The processing system 200 can implement an integrated development environment 300, allowing unified hardware and software development and configuration of the programmable system 100 with hardware configuration files and software programming developed by the integrated development environment 300. The processing system 200 can include one or more processors 202 to implement the integrated development environment 300, for example, by executing instructions stored in a memory system 204 or other computer readable medium.

After hardware configuration files and software programming is developed, the processing system 200 can program and/or configure the programmable system 100 with the developed hardware configuration and software programming, for example, through a coupling device 230. In some embodiments, the coupling device 230 can be a wired device, such as a Universal Serial Bus (USB) cable, Ethernet cable, etc, or can represent a wireless link between the processing system 200 and the programmable system 100.

The processing system 200 can include system interface devices 206 that allow the processing system 200 to communicate with external devices, such as the user input device 210, the display device 220, and the programmable system 100. For example, the processing system 200 can include a system interface 206 to communicate with the programmable system 100 over the coupling device 230. In some embodiments, the system interface devices 206 can receive inputs, for example, through the user input device 210, and present information, for example, via the display device 220.

The processing system 200 can develop hardware and software applications for the programmable system 100 in response to user input, for example, from the user input device 210. The integrated development environment 300 can include various development tools that allow system designers to describe hardware circuitry for the programmable system 100 to implement and to provide software or firmware code for the microcontroller 102. In some embodiments, the integrated development environment 300 can receive hardware description code that describes this hardware circuitry in an abstracted or generic manner, and can convert the generic code into device-specific configuration files that are particular to the architecture and/or resources of the programmable system 100. The hardware description code provided by the system designers can include schematic circuit diagrams and/or hardware code written according to a hardware description language, such as Verilog or VHDL.

The processing system 200 can also generate application programming interfaces based at least in part on the hardware description code. These application programming interfaces, when provided to the programmable system 100, can program the microcontroller 102 to communicate with the programmable digital and/or analog blocks 132 and 134 configured according to the device-specific configuration files.

The processing system 200 can send the device-specific configuration files and the application programming interfaces to the programmable system 100. The programmable system 100 can utilize the configuration files to configure particular hardware components in the programmable digital and/or analog blocks 132 and 134 to implement the hardware circuitry described by the hardware description code. The programmable system 100 can utilize the application programming interfaces to program the microcontroller 102 to communicate with the programmable digital and/or analog blocks 132 and 134 configured according to the device-specific configuration files.

After the programmable system 100 has been programmed with the hardware configuration and software or firmware programming developed with the integrated development environment 300, the processing system 200 can include debug hardware 208 to perform debugging operations on the programmable system 100. In some embodiments, the debug hardware 208 can be located externally from the processing system 200 and can communicate with the processing system 200 via the system interface devices 206.

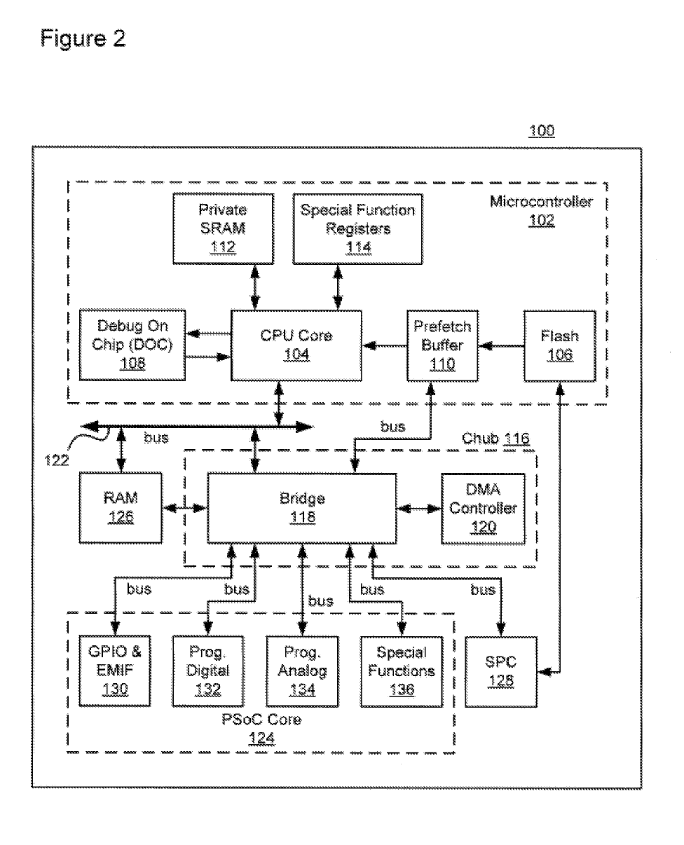

FIG. 2 illustrates an embodiment of a core architecture of a Programmable System-on-Chip (PSoC™), such as that used in the PSoC3™ family of products offered by Cypress Semiconductor Corporation (San Jose, Calif.). Referring to FIG. 2, in one embodiment, the core architecture includes the microcontroller 102. The microcontroller 102 includes a CPU (central processing unit) core 104, flash program storage 106, DOC (debug on chip) 108, a prefetch buffer 110, a private SRAM (static random access memory) 112, and special functions registers 114. In an embodiment, the DOC 108, prefetch buffer 110, private SRAM 112, and special function registers 114 are coupled to the CPU core 104, while the flash program storage 106 is coupled to the prefetch buffer 110. The flash program storage 106 can be any type of program memory.

The core architecture may also include a CHub (core hub) 116, including a bridge 118, such as a single-level or multi-level Advanced High-Performance Bus Bridge, and optionally a DMA (direct memory access) controller 120, that is coupled to the microcontroller 102 via bus 122. The Chub 116 may provide the primary data and control interface between the microcontroller 102 and its peripherals and memory, and a programmable core 124. The DMA controller 120 may be programmed to transfer data between system elements without burdening the CPU core 104. In various embodiments, each of these subcomponents of the microcontroller 102 and CHub 116 may be different with each choice or type of CPU core 104. The Chub 116 may also be coupled to shared SRAM 126 and an SPC (system performance controller) 128. The private SRAM 112 is independent of the shared SRAM 126 that is accessed by the microcontroller 102 through the bridge 118. The CPU core 104 accesses the private SRAM 112 without going through the bridge 118, thus allowing local register and RAM accesses to occur simultaneously with DMA access to shared SRAM 126. Although labeled here as SRAM, these memory modules may be any suitable type of a wide variety of (volatile or non-volatile) memory or data storage modules in various other embodiments.

In various embodiments, the programmable core 124 may include various combinations of subcomponents (not shown), including, but not limited to, a digital logic array, digital peripherals, analog processing channels, global routing, analog peripherals, DMA controller(s), SRAM and other appropriate types of data storage, IO ports, and other suitable types of subcomponents. In one embodiment, the programmable core 124 includes a GPIO (general purpose IO) and EMIF (extended memory interface) block 130 to provide a mechanism to extend the external off-chip access of the microcontroller 102, a programmable digital block 132, a programmable analog block 134, and a special functions block 136, each configured to implement one or more of the subcomponent functions. In various embodiments, the special functions block 136 may include dedicated (non-programmable) functional blocks and/or include one or more interfaces to dedicated functional blocks, such as USB, a crystal oscillator drive, JTAG, and the like.

The programmable digital block 132 may include a digital logic array including an array of digital logic blocks and associated routing. In one embodiment, the digital block architecture is comprised of UDBs (universal digital blocks). For example, each UDB may include an ALU together with CPLD functionality or other types of digital programmable logic functions.

In various embodiments, one or more UDBs of the programmable digital block 132 may be configured to perform various digital functions, including, but not limited to, one or more of the following functions: a basic I2C slave; an I2C master; a SPI master or slave; a multi-wire (e.g., 3-wire) SPI master or slave (e.g., MISO/MOSI multiplexed on a single pin); timers and counters (e.g., a pair of 8-bit timers or counters, one 16 bit timer or counter, one 8-bit capture timer, or the like); PWMs (e.g., a pair of 8-bit PWMs, one 16-bit PWM, one 8-bit deadband PWM, or the like), a level sensitive I/O interrupt generator; a quadrature encoder, a UART (e.g., half-duplex); delay lines; and any other suitable type of digital function or combination of digital functions which can be implemented in a plurality of UDBs.

In other embodiments, additional functions may be implemented using a group of two or more UDBs. Merely for purposes of illustration and not limitation, the following functions can be implemented using multiple UDBs: an I2C slave that supports hardware address detection and the ability to handle a complete transaction without CPU core (e.g., CPU core 104) intervention and to help prevent the force clock stretching on any bit in the data stream; an I2C multi-master which may include a slave option in a single block; an arbitrary length PRS or CRC (up to 32 bits); SDIO; SGPIO; a digital correlator (e.g., having up to 32 bits with 4× over-sampling and supporting a configurable threshold); a LINbus interface; a delta-sigma modulator (e.g., for class D audio DAC having a differential output pair); an I2S (stereo); an LCD drive control (e.g., UDBs may be used to implement timing control of the LCD drive blocks and provide display RAM addressing); full-duplex UART (e.g., 7-, 8- or 9-bit with 1 or 2 stop bits and parity, and RTS/CTS support), an IRDA (transmit or receive); capture timer (e.g., 16-bit or the like); deadband PWM (e.g., 16-bit or the like); an SMbus (including formatting of SMbus packets with CRC in software); a brushless motor drive (e.g., to support 6/12 step commutation); auto BAUD rate detection and generation (e.g., automatically determine BAUD rate for standard rates from 1200 to 115200 BAUD and after detection to generate required clock to generate BAUD rate); and any other suitable type of digital function or combination of digital functions which can be implemented in a plurality of UDBs.

The programmable analog block 134 may include analog resources including, but not limited to, comparators, mixers, PGAs (programmable gain amplifiers), TIAs (trans-impedance amplifiers), ADCs (analog-to-digital converters), DACs (digital-to-analog converters), voltage references, current sources, sample and hold circuits, and any other suitable type of analog resources. The programmable analog block 134 may support various analog functions including, but not limited to, analog routing, LCD drive IO support, capacitive sensing, voltage measurement, motor control, current to voltage conversion, voltage to frequency conversion, differential amplification, light measurement, inductive position monitoring, filtering, voice coil driving, magnetic card reading, acoustic doppler measurement, echo-ranging, modem transmission and receive encoding, or any other suitable type of analog function.

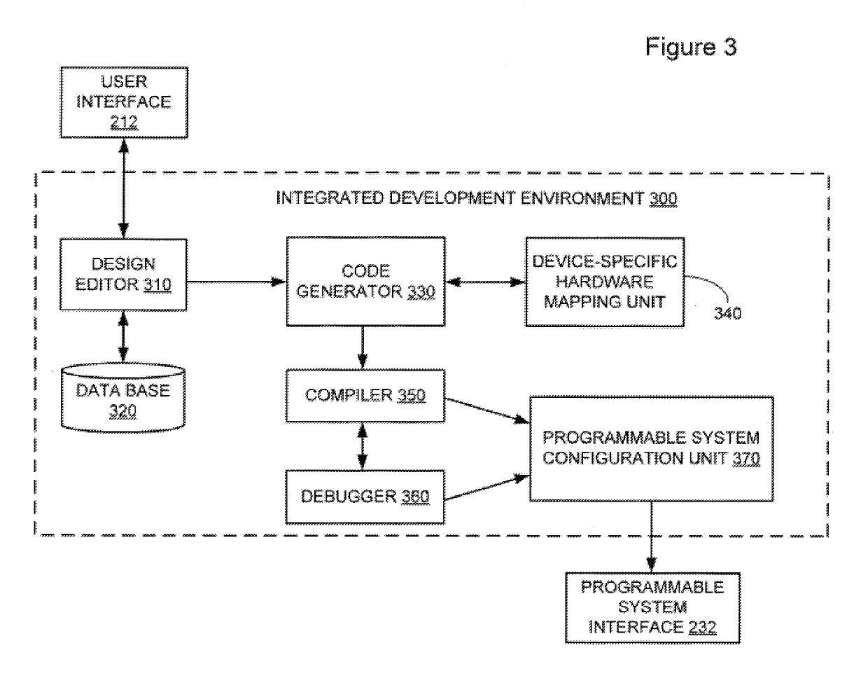

FIG. 3 illustrates an example embodiment of the processing system 200 shown in FIG. 1. Referring to FIG. 3, the processing system 200 can implement the integrated development environment 300, for example, by executing instructions stored in the memory system 204 or other computer-readable medium. In some embodiments, the integrated development environment 300 can be at least partially implemented by a set of one or more discrete hardware components (not shown) in the processing system 200.

The integrated development environment 300 can include a design editor 310 to receive information describing hardware circuitry. This information describing hardware circuitry can be received from various sources and in various formats, for example, through a user interface 212. The design editor 310 can include various development tools that present a user or system designer options for inputting circuit designs or descriptions to the integrated development environment 300. For instance, the design editor 310 can receive code written according to a hardware description language, such as Verilog or VHDL. The design editor 310 can also provide a graphics-based circuit design application, such as a Schematic Editor, a Symbol Editor, a GPIF (General Programmable Interface) editor, etc, which allows designers to create schematic diagrams of the hardware circuitry to be implemented by the programmable system 100. In some embodiments, the design editor 310 can access a database 320 to help determine dependency, build rules, and debug rules for the received descriptions of the hardware circuitry.

The design editor 310 can also receive user-generated program code from the user interface 222. The program code can utilize at least one application programming interface generated by the integrated development environment to communicate with the hardware components in the programmable system 100. This program code can also include at least one application programming interface to allow the microcontroller 102 in the programmable system 100, when programmed with the code, to communicate with hardware components in the programmable system 100.

The integrated development environment 300 can include a code generator 330 to generate configuration files from the received descriptions of the hardware circuitry. In some embodiments, when the received descriptions of the hardware circuitry are in an abstracted or generic format, the code generator 330 can access a device-specific hardware mapping unit 340 to map the received descriptions of the hardware circuitry to the programmable digital and/or analog blocks 132 and 134 of the programmable system 100. In other words, the code generator 330 can determine where and how the programmable system 100 implements the generic circuitry provided by the user or system designer. This level of abstraction can allow users without specific knowledge of the programmable system 100 the ability to program and configure the programmable system 100 to perform various applications through the use of generic circuit descriptions and diagrams. The code generator 330 can generate the configuration files from the device-specific version of the hardware circuitry descriptions.

The code generator 330 can also generate application programming interfaces from the received descriptions of the hardware circuitry. The application programming interface, when provided to the programmable system 100, can program the microcontroller 102 and allow it to communicate with hardware components of the programmable system 100.

The integrated development environment 300 can include a compiler 350 to compile the configuration files and the application programming interfaces and link them to the programmable system 100. Once the configuration files and the application programming interfaces have been compiled and linked, the compiler 350 can provide them to a programmable system configuration unit 370 to send them to the programmable system 100, for example, via a programmable system interface 232. The programmable system 100 can configure its programmable digital and/or analog blocks 132 and 134 according to the configuration files and program the microcontroller 102 according to the application programming interfaces in order to implement the hardware circuitry described by the user.

The compiler 350 can also provide the configuration files and the application programming interfaces to a debugger 360, such as the debug hardware 208. The debugger 360 can perform debugging operations on the programmable system 100 as configured with the configuration files and the application programming interfaces. For instance, the debugger 360 can perform step over, step into, and step out operations, which allows users the ability to perform incremental evaluations that step through programming code.

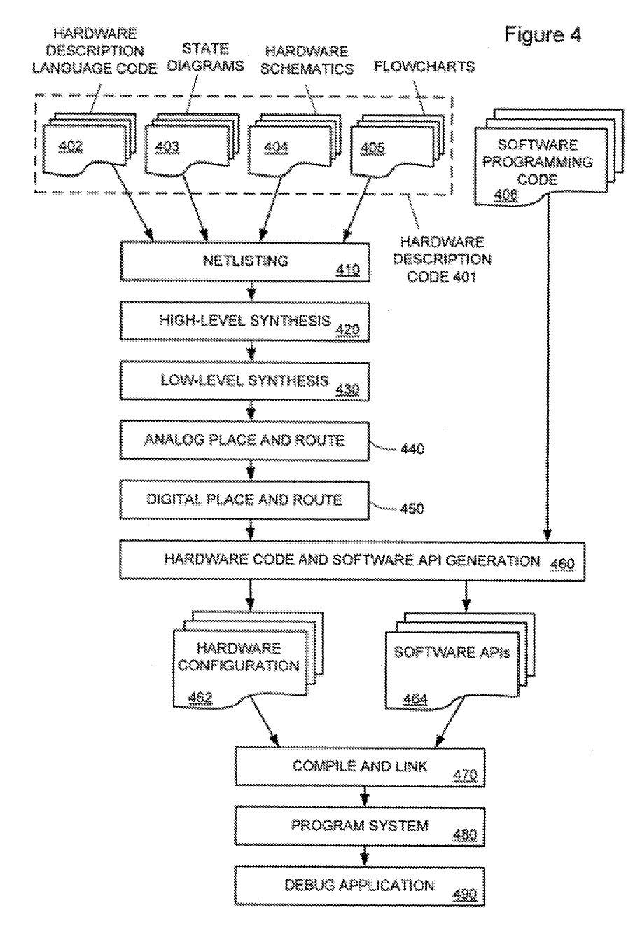

FIG. 4 is an example operational flowchart for the processing device implementing the integrated development environment 300 according to embodiments of the invention. Referring to FIG. 4, the integrated development environment 300 can receive hardware description code 401, such as hardware description language code 402, state diagrams 403, hardware schematics 404, and flowcharts 405, which can describe hardware circuitry. The hardware circuitry can include one or more circuits to perform various application or functions and analog and/or digital signal routing associated with the circuits. The hardware description language code 402 can be written in Verilog, VHDL, or other similar hardware description language. The hardware schematics 404 can be schematic diagrams of the hardware circuitry created with a graphics-based circuit design application, such as a Schematic Editor, a Symbol Editor, a GPIF (General Programmable Interface) editor, etc.

The integrated development environment 300, in a block 410, can netlist the hardware description language code 402, the state diagrams 403, the hardware schematics 404, and/or the flowcharts 405 into a single representation of the hardware circuitry to be implemented by the programmable system 100. This netlisting of the hardware description language code 402, the state diagrams 403, the hardware schematics 404, and/or the flowcharts 405 can combine and integrate the circuitry descriptions, which have various formats, into the single representation of the hardware circuitry.

The integrated development environment 300, in a block 420, can perform high-level synthesis on the netlisted hardware description code. The high-level synthesis can break-down or reduce the netlisted hardware description code into lower level primitives, logic equations, and/or flip-flops. This reduction of the netlisted hardware description code allows the integrated development environment 300, in a block 430, to map the reduced hardware description code to the programmable system 100 through low-level synthesis. The integrated development environment 300 can determine which hardware resources or components within the program system 100, such as the programmable digital blocks 132 and the programmable analog blocks 134, can implement the circuitry described by the reduced hardware description code according to a mapping.

The integrated development environment 300, in blocks 440 and 450, can perform placement and routing for both the programmable digital blocks 132 and the programmable analog blocks 134 of the programmable system 100. The placement and routing can determine where the hardware circuitry is to be placed in the programmable digital blocks 132 and the programmable analog blocks 134. The placement and routing can also allocate or set signal routing for the hardware circuitry placed in the programmable digital blocks 132 and the programmable analog blocks 134.

The integrated development environment 300, in a block 460, can generate perform hardware configuration files and application programming interfaces. The hardware configuration files can be based on the mapping of the reduced hardware description code and the place and routing analysis performed in blocks 430-450. The application programming interfaces can be based on the mapping of the reduced hardware description code and the place and routing performed in blocks 430-450, and can be based on software programming code 406 received from at least one system interface. The software programming code can include at least one application programming interface to allow the microcontroller 102 in the programmable system 100, when programmed with the software programming code, to communicate with hardware components in the programmable system 100.

The integrated development environment 300, in a block 470, can compile the hardware configuration files and the application programming interfaces, and link them to the programmable system 100. The integrated development environment 300, in a block 480, can send the compiled and linked hardware configuration files and the application programming interfaces to the programmable system 100. The programmable system 100 can be configured to implement the hardware circuitry described in the hardware description language code 402, the state diagrams 403, the hardware schematics 404, and/or the flowcharts 405 responsive to the hardware configuration files and the application programming interfaces. The integrated development environment 300, in a block 490, can execute a debugging application to debug the programmable system 100 as configured with the hardware configuration files and the application programming interfaces.

In some embodiments, the integrated development environment 300 can receive an indication to initiate automatic configuration and programming of the programmable system 100 after receiving the input information 402, 404, and 406. The integrated development environment 300 can automatically perform operations associated with the blocks 410-490 in response to receiving the indication. In some embodiments, the indication can be received from a user via at least one of the system interfaces. Although FIG. 4 shows blocks 410-490 being performed in a particular processing order, in some embodiments the integrated development environment 300 can perform the operations in different orders.

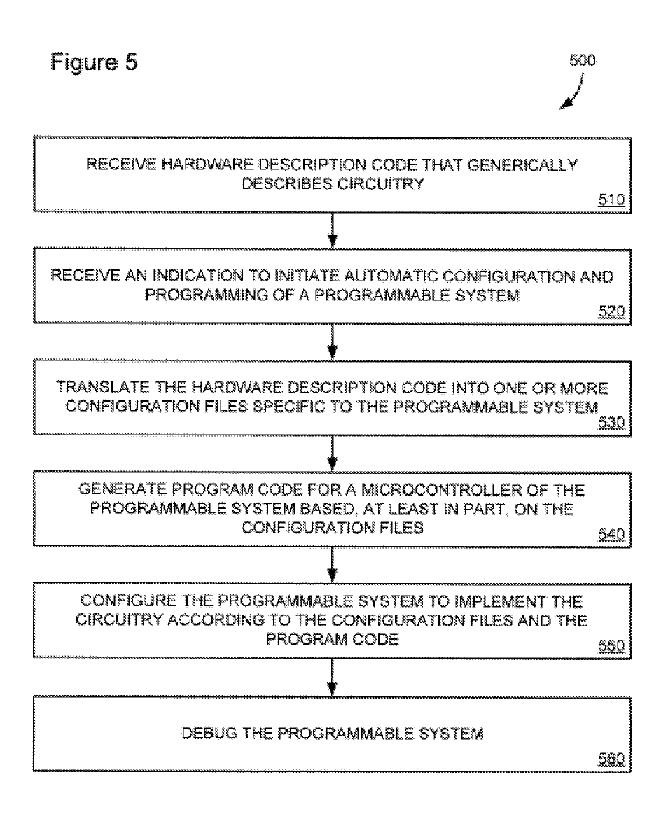

FIG. 5 is an example operational flowchart of the integrated development environment 300 according to embodiments of the invention. Referring to FIG. 5, in a first block 510, the integrated development environment 300 can receive hardware description code that generically describes circuitry. In some embodiments, the hardware description code can be code written in Verilog, VHDL, or other similar hardware description language, or schematic diagrams of the circuitry created with a graphics-based circuit design application, such as a Schematic Editor, a Symbol Editor, a GPIF (General Programmable Interface) editor, etc. The integrated development environment 300 can also receive program code for a microcontroller 102 in the programmable system 100.

In a next block 520, the integrated development environment 300 can receive an indication to initiate automatic configuration and programming of the programmable system. In some embodiments, the indication can be received from a user via at least one of the system interfaces. The integrated development environment 300 can automatically perform the blocks 530-560 in response to receiving the indication.

In block 530, the integrated development environment 300 can translate the hardware description code into one or more configuration files specific to a programmable system 100. The translation of the hardware description code into the configuration files can include multiple operations. For example, the hardware description code can be netlisted into a single representation of the circuitry. The netlisted code can be reduced into lower-level primitives, logic expressions, and flip-flops. The reduced code can be mapped to the programmable device 100 to determine how the programmable system 100 can implement the circuitry. The mapped code can be analyzed to determine placement and routing of the circuitry implemented by the programmable system 100. The integrated development environment 300 can translate the mapped code that has undergone placement and routing analysis into one or more configuration files that are specific to the programmable system 100.

In block 540, the integrated development environment 300 can generate program code for a microcontroller 102 of the programmable system 100 based, at least in part, on the hardware description code. In some embodiments, the program code can be application programming interfaces for the microcontroller 102 to communicate with the hardware components of the programmable system 100.

In block 550, the integrated development environment 300 can configure the programmable system 100 to implement the circuitry according to the configuration files and the program code. The integrated development environment 300 can provide the configuration files and the program code to the programmable system 100. The configuration files and the program code can prompt the programmable system 100 to implement the circuitry described by the hardware description code.

In block 560, the integrated development environment 300 can debug the programmable system 100 as programmed by the configuration files and the program code.

According to one embodiment, a schematic designer, such as design editor 310 described above, provides the ability to display and edit both internal components of programmable system 100 and external components in a single schematic entry. The schematic designer can identify those components which are to be place and routed on-chip (e.g., in microcontroller 102) and differentiate them from components in the schematic which are external to the device and will therefore not be placed or routed in the integrated development environment 300. These external components, however, may form part of a circuit simulation which utilizes both internal and external components.

One embodiment includes a method to place objects in a single schematic or diagram that represent components both internal and external to the device to be configured, and to automatically determine placement of those objects. The connection point or points between the internal and external objects may be automatically defined at a logical boundary.

In general, current microcontrollers, CPLDs and FPGA design tools only show internal configuration components. On the other hand, tools used to create system level schematics do not show the internal schematic of configured devices in the same view. In other words these tools do not combine the entire design in a single view. These tools do not generate a single schematic that contains both internal and external objects without affecting the tools' ability to generate the internal chip configuration.

In embodiments of the present invention, a circuit, such as an active filter, can be designed (e.g., including an internal opamp as well as external components used to implement the filter), and both the internal and external components can be displayed and configured at the same time. The example below is one application of how this schematic designer may be used in PSoC Creator.

In one embodiment the schematic designer relies on the concept of annotating a schematic. The annotation may be an invaluable tool to engineers and designers who are working with PSoC Creater. The addition of external components and connections to a schematic may help convey system design and how the device operates within the design in a way that no other design product can.

In one embodiment, annotation includes the addition of a schematic annotation layer to the PSoC Creator schematic. The annotaction layer forces a separation of all annotation elements into a separate layer that is disabled from placement and routing by default. In one embodiment, the schematic designer warns the user when an annotation element is placed into the schematic that the element serves no function other than to provide documentation of the design.

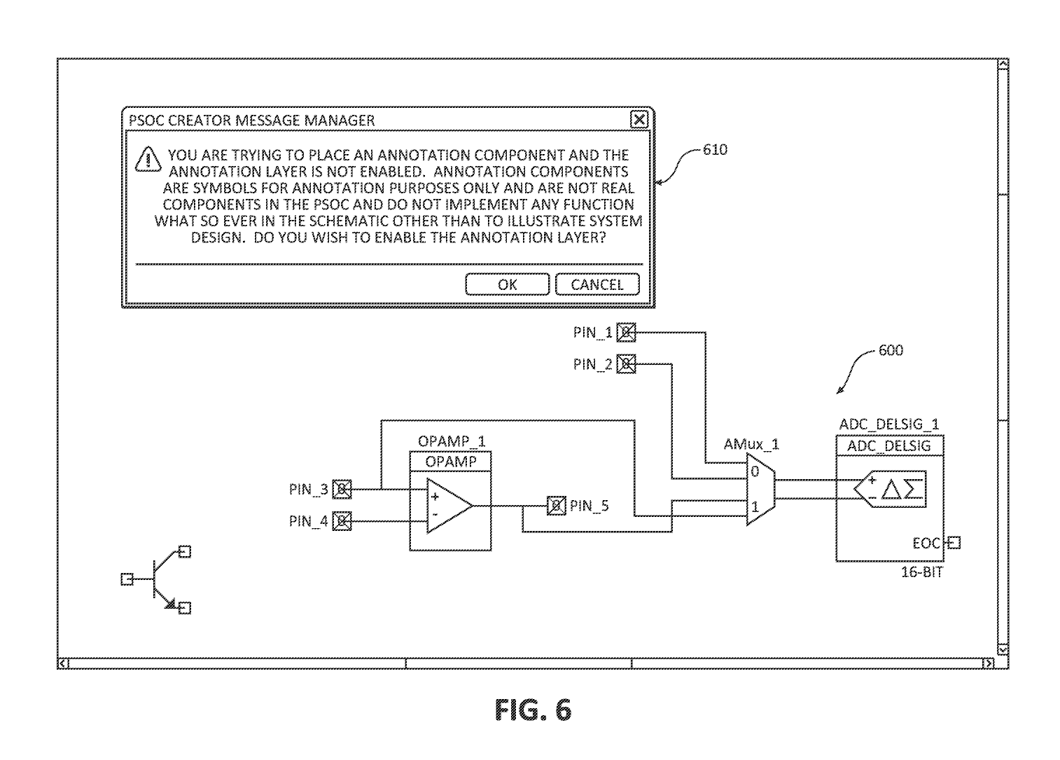

FIG. 6 is an example screen shot showing a warning dialog for annotation elements in a schematic generator, according to embodiments of the invention. In one embodiment, the schematic designer interface 600 displays the objects or components used in the design. If one of the objects added to the design is designated as an annotation element (e.g., because it represents an external component for the device being designed), a warning dialog 610 may be displayed. For example, the warning dialog 610 may include text indicating that the annotation element is a symbol for annotation purposes only and the corresponding component will not implement any function in the device schematic. If annotation layers are not currently enabled or no annotation layers currently exist, the warning dialog 610 may ask the user whether they wish to create or enable an annotation layer. If the user agrees, the schematic designer may add the annotation element to the design as part of the annotation layer (or some other defined domain). If the user does not agree, the schematic designer may not add the annotation element to the schematic.

Annotation elements may be designed with the existing tools for creating components, and a property (e.g., “annotation”) of the object may be set to indicate that the component is to be placed in the annotation layer. In one embodiment, all “hot spots” on an annotation component (e.g., wire connections, digital or analog) will also be forced to the annotation layer.

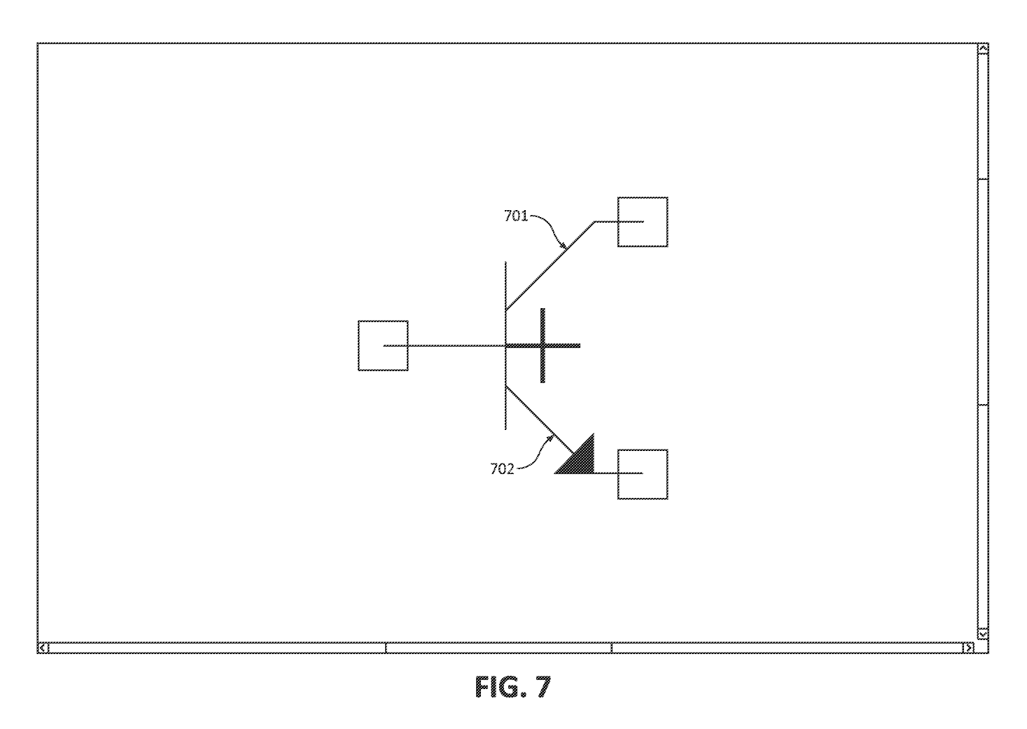

FIG. 7 is an example screen shot showing the differentiation of annotation elements in a schematic generator, according to embodiments of the invention. Wires that connect to annotation hot spots may be forced to the annotation layer. Wires and other components with the annotation property may include a visual indication to indicate their nature. For example, internal components, such as wire 701 may be present in a default manner. Annotation elements (e.g., representing external components), such as wire 702, however, may be present in a different manner. The annotation elements may have, for example, a different color, size, shape, weight, thickness, opacity or shading. They may be drawn using dashed or dotted lines. The visual indication may be any feature of the objects that distinguishes annotation objects from non-annotation objects (or objects in one domain from objects in a different domain).

In one embodiment, the annotation layer can be disabled to clearly indicate what elements are contained within the device and what elements are external. When the annotation layer is disabled, all the elements in the annotation layer may be removed from the displayed schematic and leave behind the creator components which are actually implemented in the PSoC design.

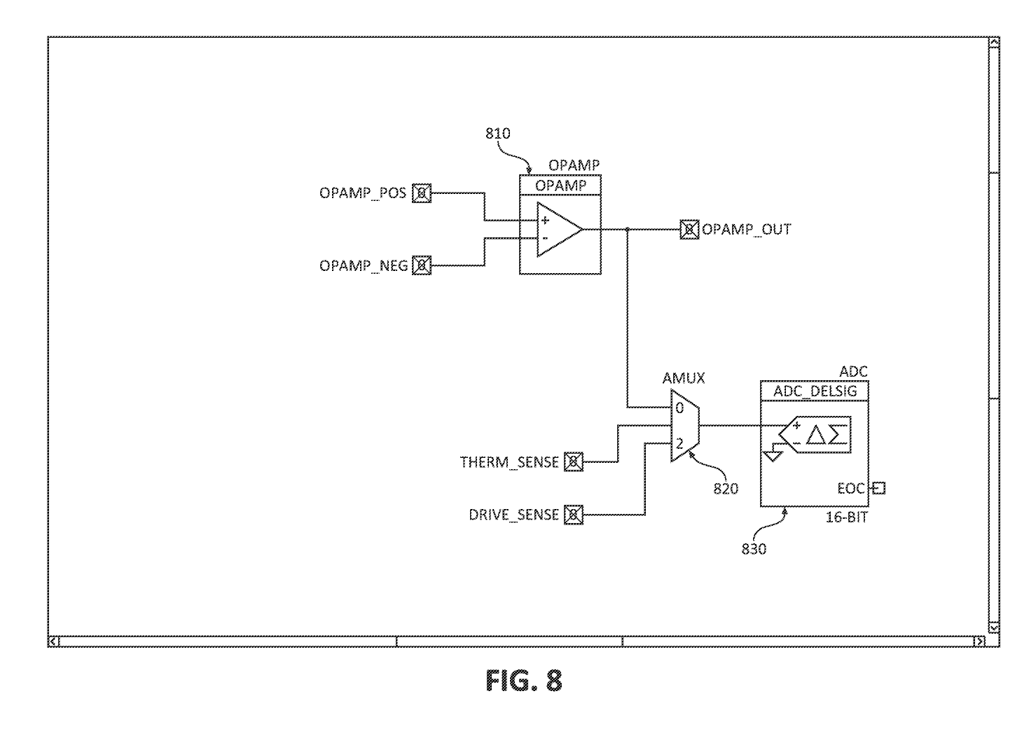

FIG. 8 is an example screen shot showing components in a first domain in a schematic generator, according to embodiments of the invention. In one embodiment, the objects 810, 820 and 830 represent internal components to the device being designed. Thus, the illustrated domain/layer may be a device domain or other non-annotation domain or layer.

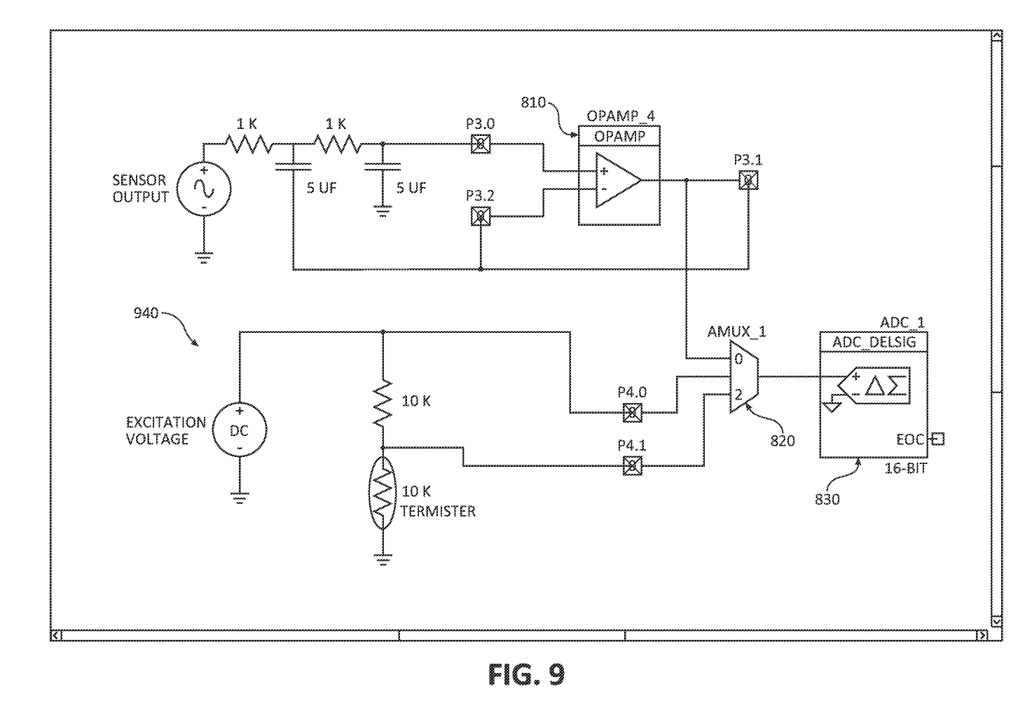

FIG. 9 is an example screen shot showing components in both a first domain and a second domain in a schematic generator, according to embodiments of the invention. In this embodiment, objects 810, 820 and 830 are illustrated as well as additional objects 940. The additional objects 940 are external objects that are part of the annotation layer. As illustrated, objects 810, 820 and 830 are drawn with darker solid lines, while additional objects 940 are drawn with lighter dotted lines. This visual indication signifies the differentiation between the device layer and the annotation layer.

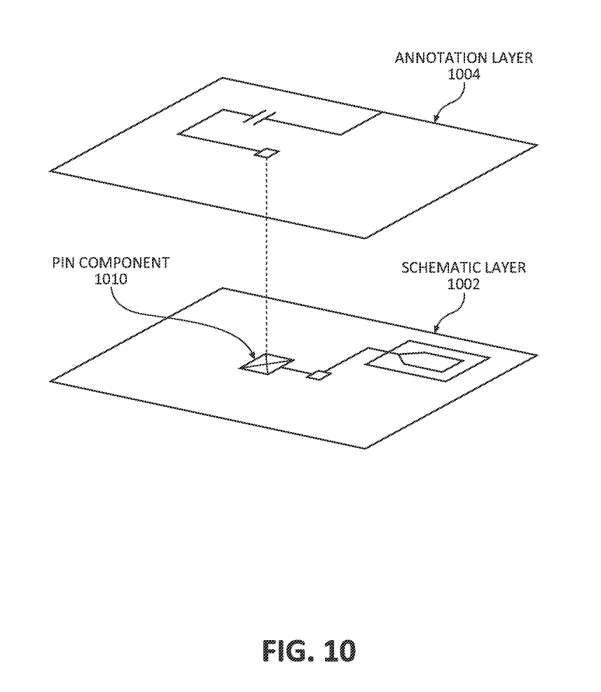

FIG. 10 is a diagram showing a logic separation between a first domain and a second domain for a schematic generator, according to embodiments of the invention. In one embodiment, a schematic design may include objects that span between multiple layers. One example of these objects is a pin 1010 or other I/O component which defines a logical boundary between the domains 1002 and 1004. The tool is aware of this and place connections between the domains at this logical boundary automatically.

In one embodiment, an advanced feature which could now be offered is the ability to export a netlist of all connections made externally to the PSoC and even provide footprints for the external components (e.g., a customizer option). T hese netlists could then be imported into a layout tool to greatly speed up design time with PSoC. A further use of the annotation layer schematic would be to export a netlist for an entire analog system simulation. In other embodiments, there may be multiple annotation layers on the same schematic page. These separate annotation layers may be separately added or removed from the schematic, however, none of the object contained in the annotation layers will be placed and routed on-chip.

One advantage of the schematic designer described herein is that it lets the user visualize and configure the entire design, including the components that he may have little or no control over. Allowing external components to be placed and configured in the development tool, greatly improves design documentation and promotes system understanding.

In one embodiments, this same concept could be implemented without layers, but instead by tagging the components to keep track of which are internal and external components. For example each component could have a tag field in the properties, for which the designer could select or input a corresponding tag. Objects with a given tag (e.g., “annotation” or “external”) could be treated as the annotation objects described above.

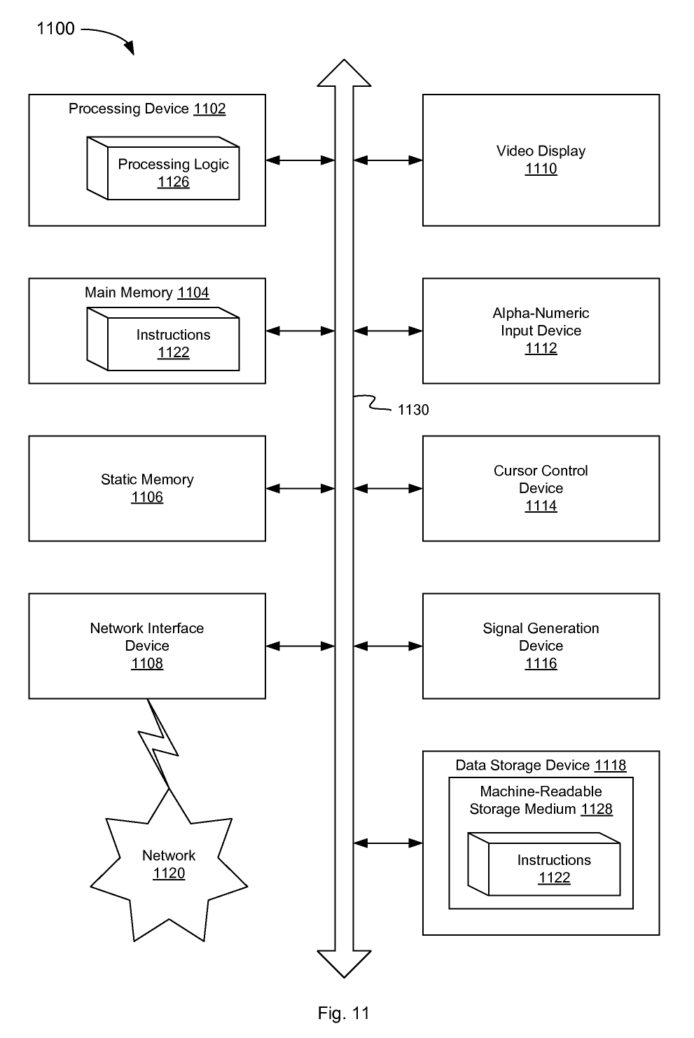

FIG. 11 illustrates a diagrammatic representation of a machine in the exemplary form of a computer system 1100 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1100 may be representative of a processing system, such as processing system 200.

The exemplary computer system 1100 includes a processing device 1102, a main memory 1104 (e.g., read-only memory (ROM), flash memory, dynamic random access memory (DRAM) (such as synchronous DRAM (SDRAM) or Rambus DRAM (RDRAM), etc.), a static memory 1106 (e.g., flash memory, static random access memory (SRAM), etc.), and a data storage device 1118, which communicate with each other via a bus 1130. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 1102 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 is configured to execute processing logic 1126 for performing the operations and steps discussed herein.

The computer system 1100 may further include a network interface device 1108. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1116 (e.g., a speaker).

The data storage device 1118 may include a machine-readable storage medium 1128, on which is stored one or more set of instructions 1122 (e.g., software) embodying any one or more of the methodologies of functions described herein. The instructions 1122 may also reside, completely or at least partially, within the main memory 1104 and/or within the processing device 1102 during execution thereof by the computer system 1100; the main memory 1104 and the processing device 1102 also constituting machine-readable storage media. The instructions 1122 may further be transmitted or received over a network 1120 via the network interface device 1108.

The machine-readable storage medium 1128 may also be used to store instructions to perform a method for schematic design including components that are both internal and external to the device being configured, as described herein. While the machine-readable storage medium 1128 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

One of skill in the art will recognize that the concepts taught herein can be tailored to a particular application in many other ways. In particular, those skilled in the art will recognize that the illustrated embodiments are but one of many alternative implementations that will become apparent upon reading this disclosure.

The preceding embodiments are examples. Although the specification may refer to “an”, “one”, “another”, or “some” embodiment(s) in several locations, this does not necessarily mean that each such reference is to the same embodiment(s), or that the feature only applies to a single embodiment.

What is claimed is:

1. A method of configuring a programmable device, comprising:
providing a design interface to design a device schematic for the programmable device;
receiving a placement of graphical objects in the device schematic, wherein the graphical objects represent components that are both internal and external to the programmable device being configured;
assigning the graphical objects into one of an internal domain and an external domain; and
displaying, by a processing device, the graphical objects from both the internal domain and the external domain in a single view of the design interface.

2. The method of claim 1, wherein the programmable device comprises one or more programmable analog blocks, the device schematic to configure the one or more programmable analog blocks.

3. The method of claim 1, wherein the internal domain comprises graphical objects representing components to be placed and routed on the programmable device being configured.

4. The method of claim 1, wherein the external domain comprises graphical objects representing components external to the programmable device being configured, and wherein the external components are used for simulating system operation.

5. The method of claim 1, further comprising:
generating a configuration file for configuring the programmable device to implement at least a portion of the device schematic comprising graphical objects in the internal domain.

6. The method of claim 5, further comprising:
configuring the programmable device using the configuration file.

7. The method of 1, further comprising:
simulating an operation of a system comprising the programmable device being configured and the external components, wherein the simulating includes portions of the device schematic from both the internal domain and the external domain.

8. The method of claim 1, wherein the internal domain and the external domain comprise layers in the design interface.

9. A system comprising:
a programmable device to be configured; and
a processing system comprising an integrated development environment, the integrated development environment to:
provide a graphical user interface for creating a circuit schematic to configure the programmable device;
manage a placement of graphical objects in the circuit schematic, wherein the graphical objects represent components that are either internal and external to the programmable device being configured;
designate the graphical objects as part of an internal layer or an external layer of the circuit schematic; and
present the graphical objects from both the internal layer and the external layer in a single view of the graphical user interface.

10. The system of claim 9, wherein the programmable device comprises one or more programmable analog blocks, the circuit schematic to configure the one or more programmable analog blocks.

11. The system of claim 9, wherein the internal layer comprises graphical objects representing components to be placed and routed on the programmable device being configured.

12. The system of claim 9, wherein the external layer comprises graphical objects representing components external to the programmable device being configured, the external components for simulating system operation.

13. The system of claim 9, the integrated development environment further to:
generate a configuration file for configuring the programmable device to implement at least a portion of the circuit schematic comprising graphical objects in the internal layer.

14. The system of claim 13, the integrated development environment further to:
configure the programmable device using the configuration file.

15. The system of claim 9, the integrated development environment further to:
simulate an operation of a system comprising the programmable device being configured and the external components, wherein the simulating includes portions of the circuit schematic from both the internal layer and the external layer.

16. A non-transitory computer-readable storage medium storing instructions, which when executed, to cause a processing device to perform operations comprising:
providing a design interface to design a device schematic for the programmable device;
receiving a placement of graphical objects in the device schematic, wherein the graphical objects represent components that are both internal and external to the programmable device being configured;
assigning the graphical objects into one of an internal domain and an external domain; and
displaying, by the processing device, the graphical objects from both the internal domain and the external domain in a single view of the design interface.

17. The non-transitory computer-readable storage medium of claim 16, wherein the programmable device comprises one or more programmable analog blocks, the device schematic to configure the one or more programmable analog blocks.

18. The non-transitory computer-readable storage medium of claim 16, wherein the internal domain comprises graphical objects representing components to be placed and routed on the programmable device being configured, and wherein the external domain comprises graphical objects representing components external to the programmable device being configured, and wherein the external components are used for simulating system operation.

19. The non-transitory computer-readable storage medium of claim 16, the operations further comprising:
generating a configuration file for configuring the programmable device to implement at least a portion of the device schematic comprising graphical objects in the internal domain; and
configuring the programmable device using the configuration file.

20. The non-transitory computer-readable storage medium of 16, the operations further comprising:
simulating an operation of a system comprising the programmable device being configured and the external components, wherein the simulating includes portions of the device schematic from both the internal domain and the external domain.
